(19) United States
(12) Patent Application Publication
(10) Pub. No.: US 2025/0385948 A1
(43) Pub. Date: Dec. 18, 2025

(54) METHOD FOR GENERATING A COMMUNICATION NETWORK IN AN AUTOMATION SYSTEM

(71) Applicant: Beckhoff Automation GmbH, Verl (DE)

(72) Inventors: Benjamin Bruns, Celle (DE); Lennart Winkler, Verl (DE); Sebastian Böse, Rietberg (DE); Henning Mersch, Verl (DE); Laurids Beckhoff, Schloß Holte-Stukenbrock (DE)

(21) Appl. No.: 19/316,622

(22) Filed: Sep. 2, 2025

Related U.S. Application Data
(63) Continuation of application No. PCT/EP2024/057808, filed on Mar. 22, 2024.

(30) Foreign Application Priority Data
Apr. 4, 2023 (DE) 10 2023 108 656.1

(51) Int. Cl. H04L 67/12; H04L 12/66

(52) U.S. Cl. CPC H04L 67/12; H04L 12/66

(57) ABSTRACT

A computer-implemented method is provided for generating a communication network between at least one OPC-UA client and at least one field device of an automation system. The method includes identifying at least one field device of the automation system via a communication gateway of the automation system in an identifying step, generating an OPC UA node set for the identified field device by the communication gateway in a generating step, and storing the OPC UA node set on an OPC UA server in a node set storing step. Related methods for data communication and data analysis are also described, along with a communication gateway and an automation system.

### CROSS-REFERENCE TO RELATED APPLICATIONS

This patent application is a continuation of International Patent Application PCT/EP2024/057808, entitled “Method for Generating a communication Network in an Automation System,” filed Mar. 22, 2024, which claims the priority of German patent application DE 10 2023 108 656.1, entitled “Verfahren zum Generieren eines Kommunikationsnetzwerks in einem Automatisierungssystem,” filed Apr. 4, 2023, each of which is incorporated by reference herein, in the entirety and for all purposes.

### FIELD

The invention relates to a computer-implemented method for generating a communication network between at least one OPC-UA client and at least one field device of an automation system, a computer-implemented method for data communication between an OPC-UA client and at least one field device of an automation system, a method for analyzing data of operating information of a field device by an OPC-UA client of a control station of an automation system and a communication gateway.

### BACKGROUND

In automation technology, analysis processes in which process operations, functionalities of individual devices or entire system sections are of great importance for the error-free execution of the automation processes to be carried out in each case. A centralized analysis of the individual automation processes or partial processes is particularly advantageous for large automation systems in which a large number of different components have to interact precisely in order to guarantee error-free operation. The analysis processes are advantageously carried out in central control stations of the automation system, in which data from individual devices or system components converge for the purpose of analysis. This requires communication channels between the control stations and components of the automation system.

### SUMMARY

The application provides a computer-implemented method for generating a communication network between at least one OPC-UA client and at least one field device of an automation system, a computer-implemented method for data communication between an OPC-UA client and at least one field device of an automation system, a method for analyzing data of operating information of a field device by an OPC-UA client and a communication gateway.

### EXAMPLES

According to an aspect of the application, a computer-implemented method for generating a communication network between at least one OPC-UA client and at least one field device of an automation system is provided, said method comprising:
identifying at least one field device of the automation system with the aid of a communication gateway of the automation system set up for data communication with the field device in an identifying step;
generating an OPC UA node set for the identified field device by the communication gateway in a generating step; and
storing the OPC-UA node set on an OPC-UA server in a node set storing step, where the OPC-UA node set stored on the OPC-UA server may be called up by at least one OPC-UA client of the automation system, and where operating information which may be provided in a data communication by the at least one field device may be stored in the OPC-UA node set and may be read in by the OPC-UA client.

This may achieve the technical advantage that an improved method for generating a communication network between an OPC UA client and at least one field device of an automation system may be provided. The communication network is automatically created by an appropriately configured communication gateway. The communication gateway is part of the communication network alongside the OPC-UA client and the field devices.

The automatic generation of the communication network with the aid of the communication gateway is particularly advantageous when integrating new field devices into an existing automation system. Here, the OPC UA node sets of the respective field device may be created automatically during integration and thus the communication network may be generated. This eliminates the need for programming in order to create the respective OPC UA node sets.

The OPC-UA communication standard is embodied as a client-server architecture with at least one OPC server and at least one OPC-UA client. The OPC-UA server comprises the information of the field devices stored or provided in OPC node sets and provides the OPC-UA client with services, for example in providing the information. The OPC-UA client may dial into the OPC-UA server in the same way as a conventional client-server architecture and use the services of the OPC-UA server. For example, the OPC-UA client may read in the field device information provided in the OPC-UA node sets.

The OPC UA node set comprises a number of nodes and references in the address space of the OPC UA server that connect the nodes with one another. The nodes may represent objects, variables and methods of the respective field device. In addition, nodes may represent object types or object classes, variable types or variable classes, data types or data structures and reference types of the respective field device. The nodes of the OPC UA node set may also be assigned attributes, such as an address or a name of the node. A node representing a variable may also be assigned, for example, the attribute of the value of the respective variable, a data type or access rights for reading or writing the respective value by an OPC-UA client. The structure of the OPC UA node sets, in particular the nodes and references, may be standardized for the individual field devices in accordance with the OPC UA Companion Specifications for the respective device types of the field devices.

OPC-UA Companion Specifications describe industry-specific standards regarding the communication models to be used for data communication with devices in the respective industry.

The OPC-UA client may be embodied as a terminal of a control station of the automation system. The OPC-UA client may be embodied as a computer workstation, a PC or a software module. The OPC-UA client may also include a further gateway for data conversion.

According to an embodiment, the generation of the OPC UA node set comprises:
reading out from an internal database at least one piece of configuration information relating to the identified field device by the communication gateway in a first read-out step, where the configuration information comprises information relating to a configuration of the OPC UA node set; and
converting the configuration information read out from the internal database into the OPC UA node set in a converting step.

This may achieve the technical advantage that by reading out the configuration file of a specific field device from the internal database, the communication gateway is able to generate the corresponding OPC UA node sets. The configuration information of the internal database defines, for the respective field device, at least the type of the respective field device and the type of data that may be provided by the field device.

The configuration information may be embodied in the sense of a companion specification and include all the information required to individually create an OPC UA node set.

The configuration information may, for example, include mapping allocations that define an allocation between operating information provided by the field device and OPC UA variables of the OPC UA node set for a respective field device.

The data structures of the OPC UA node sets may be defined or stored in a converting module of the communication gateway. The data structures of the OPC UA node sets may be assigned to the respective field devices individually or depending on the device type of the field device.

As an alternative or in addition, the data structures of the OPC UA node sets may be defined in the conversion information for the field devices in addition to the mapping allocations.

Based on the configuration information, the communication gateway may generate the corresponding OPC UA node sets for the respective field devices. A cumbersome programming process in which an individual OPC UA node set is created for each field device may therefore be avoided.

After identifying the respective field device and reading out the respective configuration information, the communication gateway is able to create the OPC UA node sets independently.

According to an embodiment, the method further comprises:
reading out from the internal database at least one piece of communication information relating to the identified field device via the communication gateway in a second read-out step, where the communication information defines at least one communication command of a field bus protocol, where the field device may be triggered via the communication command to transmit the at least one operating parameter to the communication gateway; and
storing the at least one communication command in the communication gateway in a command storing step.

This may achieve the technical advantage that the communication information may be used to store the respective field device and the corresponding communication commands for a predefined field bus protocol in the communication gateway. By reading out the communication information from the internal database, the communication gateway thus receives the communication commands required for data communication with the respective field device.

By reading out the communication information for an identified field device from the internal database, the communication gateway is automatically able to communicate with the respective field device and request the operating information from it. This eliminates the need for complicated programming of the communication gateway to allow for its communication with the respective field device.

The communication information may include or define parameters that are necessary for data communication between the communication gateway and the field devices in accordance with a predefined field bus protocol.

According to an embodiment, the internal database comprises configuration information and/or communication information for a plurality of different field devices.

This may achieve the technical advantage that a comprehensive internal database is provided. The internal database comprises configuration information and/or communication information of at least all field devices present in the automation system.

Preferably, the internal database also includes configuration information and/or communication information for a number of different field devices that are not currently present in the automation system but could be integrated into it in the future. This makes it possible to access the information in the internal database when integrating a new field device into the automation system in order to generate the corresponding OPC UA node sets.

According to an embodiment, the configuration information and/or communication information of the internal database is provided by the manufacturer of the field devices.

This may achieve the technical advantage that the internal database may be expanded by adding new field devices. This allows for updating the configuration information and/or communication information stored in the internal database. This means that for newly available field devices that may be integrated into the automation system, corresponding configuration information and/or communication information is already contained in the internal database, so that when the field devices are integrated into the automation system, the corresponding information may be read out from the internal database and corresponding OPC UA node sets may be generated automatically by the communication gateway.

According to an embodiment, the method further comprises:
copying configuration information and/or communication information relating to a plurality of field devices from an external database to the internal database set up on the communication gateway by the communication gateway in a copying step, the internal database being set up on an external server.

This may achieve the technical advantage that the external database is easily accessible for manufacturers. This means that the external database may be updated at any time in such a way that the configuration information and/or communication information of the latest field devices may be added to the external database at any time. The corresponding configuration information and/or communication information may then be downloaded to the internal database of the communication gateway in order to update it.

According to an embodiment, the identified field device is a field device newly integrated into the automation system.

This may achieve the technical advantage that the communication gateway may automatically integrate a new automation system into the communication network.

According to an embodiment, the identifying step comprises:
transmitting an identification command via the communication gateway to field devices of the automation system in a transmitting step; and
receiving an identification response of the at least one field device via the communication gateway in a receiving step, where at least one device identifier of the at least one field device is defined in the identification response.

This may achieve the technical advantage of allowing for reliable identification of the field devices. The identification command may be sent via the communication gateway to a number of field devices or individually to a selected field device. In particular, a corresponding identification command may be sent via the communication gateway if it is determined that a change has been made in the field devices.

The change may include, for example, that a new field device has been integrated into the automation system. The communication gateway may then identify the field device by sending the communication command in order to read the respective configuration information and/or communication information of the respective field device from the internal database and generate corresponding OPC UA node sets and store them in the OPC UA server. This allows for automatic generating of the communication network when the new field device is identified.

According to an aspect, a computer-implemented method for data communication between an OPC-UA client and at least one field device of an automation system is provided, comprising:
generating a communication network between the OPC-UA client and the at least one field device of the automation system by carrying out the method for generating a communication network between an OPC-UA client and at least one field device according to any one of the preceding embodiments by a communication gateway in a network generating step;
receiving a communication message from the field device via the communication gateway in a message receiving step, where the communication message contains at least one piece of operating information relating to at least one operating parameter of the field device;
storing the operational information related to the operational parameter of the field device in the OPC UA node set on the OPC UA server in an information storing step; and
providing the operating information regarding the operating parameter of the field device for the OPC UA client via the OPC UA node set of the OPC UA server by the communication gateway in a providing step.

This may achieve the technical advantage that an improved method for communicating data between an OPC UA client and a field device of an automation system may be provided. In order to generate a communication network required for communicating data, the method according to the application for generating a communication network with the above-mentioned technical advantages is carried out first.

The communication network comprises at least one OPC-UA client, at least one field device and the communication gateway according to the application as an intermediary between the control station and the field devices of the automation system. In particular, the communication gateway is able to generate the communication network automatically. Data communication may therefore be initiated automatically by the communication gateway.

According to an embodiment, communication messages of the field device are received cyclically via the communication gateway, where operating information of the communication messages is correspondingly stored cyclically in the OPC UA node set of the OPC UA server.

This may achieve the technical advantage that reliable data communication may be provided between the control station and the field devices of the automation system. For this purpose, the operating information is provided cyclically by the respective identified field device; i.e., during the control cycles in which the automation system is controlled.

Accordingly, the operating information is cyclically written to the node sets created during the generation of the communication network and stored on the OPC UA server. The control station may access the operating information stored on the OPC-UA server and use it accordingly for data analysis. As the operating information is provided cyclically; i.e., during the control cycles, by the field device, the simplest possible data communication may be provided in which no additional queries by the control station to the field device are required. Actual data that may be viewed by the controller may be communicated in the data communication.

In this context, data communication primarily comprises the path from the field device to the OPC UA client, in which the operating information is provided by the field device and may be read in by the OPC UA client.

According to an embodiment, the operating parameter comprises an operating time and/or an operating performance and/or a maintenance status and/or a service life and/or a next maintenance date of the field device.

This may achieve the technical advantage that, in particular, operating information of the field device is communicated, which remains largely unconsidered during the control of the automation system by a corresponding controller. The correspondingly communicated operating information also allows for analyzing the operating status of the respective field device.

By monitoring the operating information provided by the field device in a later data analysis carried out by the OPC UA client, the utilization of the field device may be monitored and a possible time for replacing the field device may be determined. By monitoring the accumulated operating hours, the remaining service life or a planned maintenance date in a later data analysis, the respective field device may be replaced or serviced at the appropriate time.

According to an embodiment, the operational information of the field device stored in the OPC-UA node set is provided to the OPC-UA client via a point-to-point channel and/or a message channel and/or a publisher-subscriber channel and/or a message bus and/or a data type channel.

This may achieve the technical advantage of allowing for a reliable transmission of the field device's operating information from the communication gateway to the OPC UA client.

According to an aspect, a method for data analysis of operational information of a field device via an OPC-UA client of an automation system is provided, comprising:
receiving operational information provided according to the method for data communication between an OPC-UA client and at least one field device of an automation system according to any one of the preceding embodiments via the OPC-UA client in an information receiving step;
analyzing the operating information via the OPC UA client in an analyzing step; and
outputting an action instruction for stopping operation of the field device and/or for replacing the field device if the analysis has determined a malfunction and/or an operating time that has exceeded a limit value and/or an operating performance that has exceeded a limit value and/or a specific maintenance status and/or an expired service life and/or a maintenance date of the field device in an output step.

This may achieve the technical advantage that an improved method for data communication between an OPC-UA client and a field device of an automation system may be provided. In order to generate a communication network required for data communication, the method according to the application for generating a communication network with the above-mentioned technical advantages is carried out first.

The communication network comprises at least one OPC-UA client, at least one field device and the communication gateway according to the application as an intermediary between the OPC-UA client and the field devices of the automation system.

In particular, the communication gateway is able to generate the communication network automatically. Data communication may therefore be initiated automatically by the communication gateway.

According to an aspect, a communication gateway for a data communication of an OPC UA client and at least one field device of an automation system is provided, where the communication gateway is configured to carry out the method for generating a communication network according to any one of the preceding embodiments and/or the method for carrying out a data communication between an OPC UA client and at least one field device of an automation system according to any one of the preceding embodiments.

This may achieve the technical advantage that an improved communication gateway may be provided that is configured to carry out the method for generating a communication network and the method for data communication with the technical advantages described above.

In particular, the communication gateway is able to generate the communication network automatically and without the intervention of a developer. Particularly in the case of field devices newly integrated into the automation system, the communication gateway is able to generate corresponding OPC UA node sets and use them to generate the communication network.

According to an embodiment, the communication gateway comprises:
an internal database comprising configuration information and/or communication information relating to a plurality of different field devices; and/or
a field bus module, where the field bus module is configured to transmit communication commands to field devices and/or receive communication messages from field devices and/or identify field devices in a field bus protocol; and/or
a parsing module configured to read configuration information and/or communication information relating to the field devices of the automation system from the internal database, where the configuration information comprises information relating to a configuration of the OPC-UA node set, where the communication information defines at least one communication command of a field bus protocol, and where a field device may be driven via the communication command to transmit at least one operating information of the field device to the communication gateway; and/or
a converting module, where the converting module is set up to generate a corresponding OPC UA node set for each identified field device of the automation system based on the configuration information of the field devices; and/or
an OPC-UA server for storing the OPC-UA node sets of the identified field devices; and/or
an OPC-UA communication interface, where the communication gateway may be connected to an OPC-UA client via the OPC-UA communication interface, and where the OPC-UA node set may be made available to the OPC-UA client via the OPC-UA communication interface.

This may achieve the technical advantage that the communication gateway is able to carry out the method for generating a communication network and the procedure analyzing data automatically and without user intervention via the majority of different modules. In particular, when changes are made to the automation system, for example when a field device is replaced, the communication gateway may automatically create the communication network.

This eliminates the need for a developer to create a corresponding OPC UA node set or configure the field device newly integrated into the automation system. Any interruption to the automation system may therefore be limited to replacing the field devices.

According to an aspect, an automation system comprising at least one field device, at least one OPC-UA client and a communication gateway according to any one of the preceding embodiments is provided, where the OPC-UA client is configured to carry out the method for analyzing data.

This may achieve the technical advantage that an automation system may be provided which is configured to carry out data analysis with the technical advantages described above.

According to an embodiment, the OPC-UA client is implemented in a terminal of a control station in a cloud server.

This may achieve the technical advantage of allowing for centrally analyzing the operating information of the field devices. By using the cloud server, the higher computing capacity provided by this type of server may also be utilized.

### BRIEF DESCRIPTION OF THE DRAWINGS

The invention is described in more detail with reference to the attached figures, in which:

FIG. 1 is a schematic depiction of an automation system comprising a communication gateway according to an embodiment;

FIG. 2 is a flowchart of a computer-implemented method for generating a communication network between at least one OPC-UA client and at least one field device of an automation system according to an embodiment;

FIG. 3 shows a further flowchart of the computer-implemented method for generating a communication network between at least one OPC-UA client and at least one field device of an automation system according to a further embodiment;

FIG. 4 is a further flowchart of the computer-implemented method for generating a communication network between at least one OPC-UA client and at least one field device of an automation system according to a further embodiment;

FIG. 5 shows a flowchart of a computer-implemented method for data communication between an OPC-UA client and at least one field device of an automation system according to an embodiment; and

FIG. 6 shows a flowchart of a computer-implemented method for analyzing operating information of a field device by an OPC-UA client of an automation system according to an embodiment.

### DETAILED DESCRIPTION

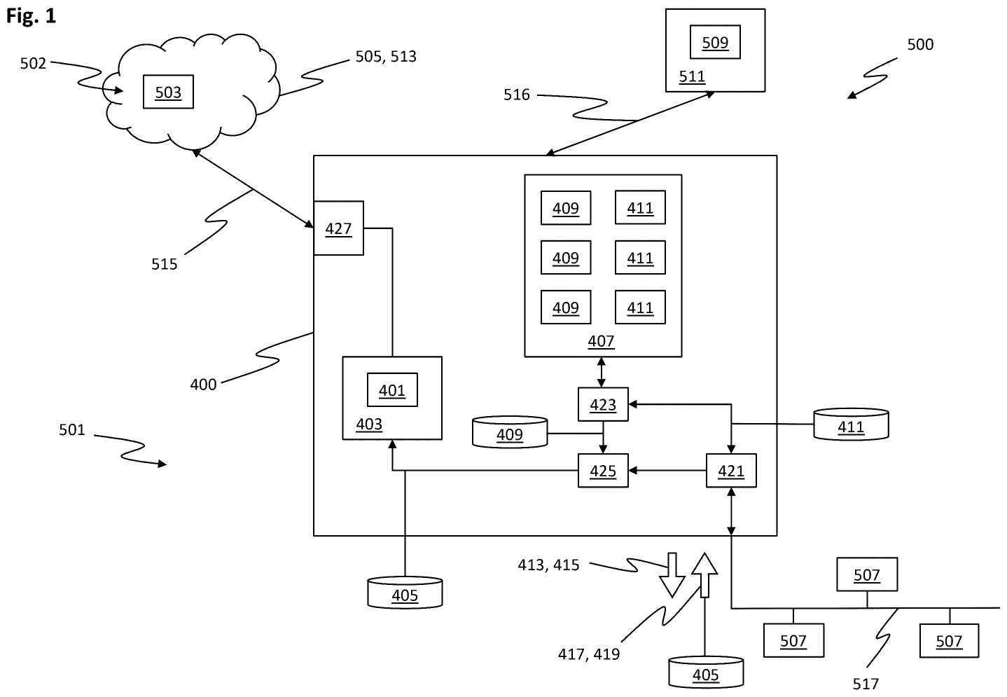

FIG. 1 shows a schematic depiction of an automation system 500 having a communication gateway 400 according to an embodiment.

In the embodiment shown, the automation system 500 comprises a communication gateway 400. The communication gateway 400 is connected to a plurality of field devices 507 via a field bus 517. The automation system 500 further comprises an OPC-UA client 502. The OPC-UA client 502 may be suitable for connection to a communication interface 427 of the communication gateway 400 via a wireless data connection 515. As an alternative, the data connection may also be wired.

In the embodiment shown, the OPC-UA client 502 is embodied as a terminal 503 of a control station 505 of the automation system 500.

In the embodiment, the control station 505 is embodied as a cloud server 513 and is connected to the communication interface 427 of the communication gateway 400 via the wireless data connection 515.

In the embodiment shown, the communication gateway 400 comprises an internal database 407. The internal database 407 stores configuration information 409 and/or communication information 411 for a plurality of different field devices 507.

The communication gateway 400 further comprises a parsing module 423. The parsing module 423 is arranged to search the internal database 407 for corresponding information and to read this information from the internal database 407.

The communication gateway 400 further comprises a field bus module 421. The field bus module 421 is configured to carry out data communication according to a field bus protocol of the field bus 517 with the plurality of field devices 507 of the automation system 500.

The communication gateway 400 further comprises a converting module 425. The converting module 425 is set up to convert information received from both the parsing module 423 and from the field bus module 421 into the OPC-UA communication standard.

In the embodiment shown, the communication gateway 400 further comprises an OPC-UA server 403. OPC-UA node sets 401 for various field devices 507 of the automation system 500 may be stored on the OPC-UA server 403 in accordance with the OPC-UA communication standard.

In the embodiment shown, the automation system 500 further comprises an external database 509 which may be executed on an external server 511. The external database 509 is connected to the communication gateway 400 via a further wireless data connection 516.

The communication gateway 400 according to the application is set up to carry out the method according to the application for generating a communication network 501 between an OPC-UA client 502 and at least one field device 507 of the automation system 500.

For the purposes of the application, the communication network 501 comprises at least one OPC UA client 502, at least one field device 507 and the communication gateway 400.

In order to generate a communication network 501 according to the application, the communication gateway 400 first identifies at least one field device 507 of the plurality of field devices 507 of the automation system 500.

Alternatively, a plurality of field devices 507, possibly all field devices 507, of the automation system 500 may be identified.

For this purpose, the communication gateway 400 may send at least one identification command 415 to the field devices 507 via the field bus 517 using the field bus module 421. The identification command 415 may be sent as a joint identification command 415 to the entire field devices 507 of the automation system 500. As an alternative or in addition, identification commands 415 may be sent to individually selected field devices 507. In the identification command 415, the respective field devices 507 are requested to identify themselves to the communication gateway 400.

For this purpose, the field devices 507 receiving the respective identification command 415 send a corresponding identification response 417 to the communication gateway 400. At least one device identifier and/or a device type of the respective field device 507 is defined in the identification response 417. The information in the identification response 417 may thus be used to identify the respective field device 507, for example, as a sensor or actuator of a certain type, i.e., as a temperature sensor or pressure sensor and/or as a servomotor of a certain design.

The corresponding information of the identification response 417 is then forwarded to the parsing module 423 by the field bus module 421. The identification response 417 may comprise a device identification code with the aid of which the respective field device 507 may be uniquely identified. The device identification code may be defined in accordance with the HART protocol.

As an alternative or in addition, the identification response 417 may comprise information regarding the device type of the respective field device 507.

The parsing module 423 is then able to search the internal database 407 for corresponding information stored for field devices 507 of the respective device type based on the information of the identification response 417, in which at least the device type or the device identifier of the respective identified field device 507 is specified.

Preferably, the internal database 407 stores configuration information 409 and/or communication information 411 for a plurality of different field devices 507 of different device types or different models of the same device type.

The parsing module 423 thus searches the configuration information 409 and/or communication information 411 of the respective field device 507 for the device identification code, i.e., the device identifier, of the field device 507.

Alternatively, the configuration information 409 or communication information 411 may also be stored in the internal database 407 according to the respective device types or designs of the device types of the field devices 705. The parsing module 423 may then be set up to search the internal database 407 for the device types.

The configuration information 409 stored for the various field devices 507 in the internal database 407 includes information regarding configurations of OPC-UA node sets 401 of the respective field devices 507.

The configuration information 409 may comprise mapping allocations, where the mapping allocations define which operating information 405 or operating parameters of the field devices 507 are to be mapped to which OPC UA variables of the field devices 507 of a respectively assigned OPC UA node set 401.

The data structures of the OPC-UA node sets 401 may be defined or stored in a converting module 425. The data structures of the OPC-UA node sets 401 may be assigned to the respective field devices 507 individually or depending on the device types of the field devices 507. In the case of individual assignment, the data structures or information relating to the data structures may be stored in relation to the device identification codes of the field devices 507.

In the present context, data structure is understood as the non-instantiated structure of the nodes and references of an OPC UA node set 401.

As an alternative or in addition, the data structures of the OPC UA node sets 401 may also be defined in the conversion information for the field devices 507 in addition to the mapping allocations.

As an alternative or in addition, configurations of the respective field devices 507 or a configuration of corresponding OPC UA node sets 401 for field devices 507 of the respective type may be defined in the configuration information 409. The configuration information 409 may define the individual features of the field device 507, for example the sensor or actuator type of the respective field device 507, as well as the data types of the information that may be provided by the field device 507.

The information of the configuration information 409 or, respectively, the data structures of the non-instantiated OPC-UA node sets 401 may be structured according to the information of a companion specification for the OPC-UA standard.

Taking into account the mapping allocations of the configuration information 409 and the data structures of the OPC-UA node sets 401, the converting module 425 is able to generate correspondingly instantiated OPC-UA node sets 401 for the field devices 507. In the instantiated node sets 401, each of which is uniquely assigned to the field devices 507, an OPC UA variable of the respective OPC UA node set 401 is uniquely assigned to each possible operating parameter that may be provided by a field device 507. Due to the instantiation, the values of the respective operating parameters that may be provided to the communication gateway 400 via the field devices 507 with the aid of data communication via the field bus protocol may be written into the OPC-UA variables of the OPC-UA node sets 401 assigned to the respective operating parameters.

The instantiated OPC-UA node sets 401 may be stored in the OPC-UA memory 403. By writing the values of the operating parameters to the OPC-UA variables of the OPC-UA node sets 401 provided for this purpose in accordance with the conversion information 409, the current values of the operating parameters provided by the field devices 507 may be stored in the OPC-UA server 403.

The communication information 411 defines parameters that are required for data communication between the communication gateway 400 and the field devices 507 in accordance with a predefined field bus protocol.

For example, when using the HART protocol as a field bus protocol, the following information may be defined in the communication information 411 for each parameter or operating information 405 of the field devices 507 to be read out:
HART Command
WriteData
WriteLength
ByteOffset
ReadLength
Type

HART command describes the communication command 413 of the HART protocol required for communication. The communication command 413 may be used to request the respective addressed field device 507 to send a requested piece of information. Depending on the requested information, a plurality of communication commands 413 may be defined for a field device 507 in the respective communication information 411. WriteData defines the data to be written. WriteLength defines the length of the data to be written. ByteOffset defines which part of the sent response contains the information to be read. ReadLength defines the length of the data to be read. Type defines the data type of the data to be read.

The contents of the communication information 411 described above only refer to the HART protocol by way of example. The present application may also be applied to other field bus protocols. For other field bus protocols, the communication information 411 may include information or communication commands 413 that differs from the information or communication commands 413 described above.

The communication information 411 thus comprises at least communication commands 413, with the aid of which data communication between the communication gateway 400 and the field devices 507 is allowed for in accordance with the respective field bus protocol used.

The communication information 411 may be defined analogously to the configuration information 409 for the respective field device 507; i.e., the communication information 411 may be stored individually in the internal database 407 for the field devices 507, for example under the respective device identification code.

Alternatively, the communication information 411 may be adapted to specific device types or specific device embodiments of the field devices 507 and may differ for different field devices 507 of different device types or different embodiments.

The internal database 407 thus comprises corresponding configuration information 409 and/or communication information 411 for at least a plurality of the field devices 507, preferably for all field devices 507, of the automation system 500.

After parsing the internal database 407, the parsing module 423 transmits the configuration information 409 of the respective identified field device 507 to the converting module 425.

The converting module 425 is embodied to generate at least one corresponding OPC UA node set 401 for the respective field devices based on the configuration information 409.

For this purpose, the converting module 425 may use the configuration information 409 for the field devices 507 of the automation system 500 to take into account the correspondingly stored data structures of the OPC-UA node sets 401 and the mapping allocations and generate correspondingly instantiated OPC-UA node sets 401 for the field devices 507.

In the instantiated OPC UA node sets 401, uniquely assigned OPC UA variables are defined in the corresponding OPC UA node sets 401 for the possible operating parameters that may be provided by the field devices 507.

The OPC-UA node sets 401 instantiated in this way may then be stored in the OPC-UA server 403.

According to the mapping allocations of the configuration information 409, the converting module 425 may then write the values of the operating information 405 or operating parameters provided by the field devices 507 into the OPC UA variables of the respective OPC UA node sets 401 provided for this purpose and store them in the OPC UA server 403.

The instantiated OPC-UA node set 401 generated according to the configuration information 409 is individually adapted to a respective identified field device 507 and has the data structure defined for a field device 507 of the respective device type according to the OPC-UA standard, i.e. according to corresponding Companion Specifications or according to a customer request compatible with the OPC-UA standard.

Furthermore, the parsing module 423 transmits the communication information 411 read out from the internal database 407 for the respective identified field device 507 to the field bus module 421. The field bus module 421 stores the information of the communication information 411 including the communication commands 413 and is thus set up to communicate with the identified field device 507 via the respective field bus protocol and to request it to send out desired information.

The OPC-UA client 502 may connect to the communication gateway 400 via the wireless data connection 515 and read the OPC-UA node sets 401 stored in the OPC-UA server 403. Depending on any personalized access rights, the OPC-UA client 502 may also write to variables of the OPC-UA node sets 401.

According to the application, this generates the communication network 501 between the OPC UA client 502 and the respective identified field device 507.

Preferably, the communication gateway 400 creates corresponding OPC-UA node sets 401 for all field devices 507 of the automation system 500 by reading the configuration information 409 from the internal database 407 and stores them in the OPC-UA server 403.

Furthermore, the corresponding communication commands 413 of the communication information 411 are stored in the field bus module 421 for all identified field devices 507, so that the field bus module 421 is set up to carry out data communication with the field devices 507 based on the field bus protocol.

According to the application, the generation of the communication network 501 is carried out automatically by the communication gateway 400. In particular when integrating a new field device 507 into the existing automation system 500, corresponding OPC-UA node sets 401 may thus be generated automatically and stored in the OPC-UA server 403 and the respective communication commands 413 of the communication information 411 may be stored in the field bus module 421.

For this purpose, when a new field device 507 is integrated into the automation system 500, the communication gateway 400 receives information that a new field device 507 has been integrated into the automation system 500 and subsequently transmits a corresponding identification command 415.

Similarly, when a new automation system 500 is started up, the communication gateway 400 may carry out a corresponding identification of the field devices 507 for the respective field devices 507 integrated in the automation system 500 and, based on this, generate the respective OPC UA node sets 401 by reading the configuration information 409 and communication information 411 stored in the internal database 407 for the respective field devices 507 and store them in the OPC UA server 403 and store the respective configuration information 409 in the field bus module 421.

A cumbersome programming process, in which a corresponding OPC UA node set 401 has to be created manually for each new field device 507 and corresponding communication commands 413 have to be generated, is no longer required.

After generating the communication network 501, the communication gateway 400 is able to carry out the method according to the application for data communication between an OPC-UA client 502 and at least one field device 507 of an automation system 500.

After setting up the communication network 501 between the OPC-UA client 502 and at least one field device 507, the communication gateway 400 receives a communication message 419 from the at least one identified field device 507 for data communication between the OPC-UA client 502 and the field device 507.

The communication message 419 comprises operating information 405 of the respective field device 507. The communication message 419 may be received cyclically by the communication gateway 400. For this purpose, the at least one field device 507 or the entire field devices 507 of the automation system 500 cyclically transmits corresponding communication messages 419. The respective communication messages 419 contain current operating information 405 of the respective field devices 507. For this purpose, the communication gateway 400 may cyclically send out corresponding requests to the field devices 507 to send out the communication information 411.

The cyclical transmission of the communication messages 419 with the aid of the field devices 507 may take place, for example, during control cycles of the automation system 500. As an alternative or in addition, the communication messages 419, including the operating information 405 contained therein, may also be transmitted by the field devices 507 in an acyclic manner.

According to an embodiment, the communication gateway 400 may first send out corresponding communication commands 413 to the respective field devices 507 to stimulate the field devices 507 to send out the communication messages 419. The transmitted communication commands 413 stimulate the field devices 507 received in accordance with the commands to transmit the respective communication messages 419.

This may occur, for example, in particular when the communication messages 419 are transmitted by the field devices 507 in an acyclic manner, in which the communication messages 419 are transmitted, for example, between successive control cycles of the automation system 500.

The communication messages 419, as well as the communication commands 413, are defined according to the respective field bus protocol used.

The communication commands 413 sent out may correspond to the communication information 411 of the internal database 407 stored in the field bus module 421.

Depending on the communication commands 413 sent out, different operating information 405 may be contained in the communication messages 419 subsequently sent out by the field devices 507. Accordingly, communication commands 413 may be aimed at retrieving different operating information 405 of the respective field devices 507.

After receiving the communication messages 419, the operating information 405 contained therein is forwarded to the converting module 425 by the field bus module 421. The converting module 425 is set up to write the operating information 405 of the field devices 507 to the OPC-UA node sets 401 assigned to the respective field devices 507 and to store the OPC-UA node sets 401 on the OPC-UA server 403 for the respective field device 507.

According to an embodiment, operating information 405 of the field devices 507 is stored in the OPC-UA server 403, in particular in the respective OPC-UA node sets 401, for a plurality of consecutive control cycles.

The operating information 405 stored in the OPC-UA node sets 401 of the OPC-UA server 403 may then be viewed by the respective OPC-UA client 502.

For this purpose, the respective OPC-UA client 502 may send corresponding read commands to the communication interface 427 of the communication gateway 400 via the wireless data connection 515. This allows for the OPC-UA client 502 to call up the OPC-UA node sets 401 stored for a specific field device 507 in the OPC-UA server 403 and to read in the operating information 405 stored therein.

The data communication between the OPC-UA client 502 and the communication gateway 400 may take place via a point-to-point channel and/or a message channel and/or a publisher-subscriber channel and/or a message bus and/or a data type channel.

The OPC-UA client 502, i.e. the terminal of the control station 503, is able to carry out or cause a data analysis of the operating information 405 of the field devices 507 of the automation system 500 by reading in, which may also include uploading the operating information 405 stored in the OPC-UA server 403, for example to a terminal 503 of the control station 505 or to the cloud server 513.

The operating information 405 may include, for example, operating parameters of the respective field devices 507. The operating parameters may include, for example, an operating time of the respective field device 507, an average load or a maximum or minimum load of the respective field device 507, an upcoming maintenance date of the respective field device 507, an error message of the respective field device 507, or other parameters describing the functionality or the operating load of the respective field device 507.

As an alternative or in addition, the operational information 405 may include information regarding a last calibration, such as the date of the calibration, information regarding the hardware version and/or software version of the field device 507, information regarding a temperature of an electronic of the field device 507, information regarding device-specific counter variables, and other device-specific information.

As an alternative or in addition, the operational information 405 may further comprise actual user data of the respective field devices 507, for example measurement data from sensors of the automation system 500.

The operating information 405 may further describe defined operating ranges of the respective field devices 507. The operating ranges may, for example, define a power or speed range in which a motor may be operated, or a pressure or temperature range in which a pressure or temperature sensor of the automation system 500 may be operated.

Based on the operating information 405 of the various field devices 507, the control station 505 may carry out a corresponding analysis of the operation or use of the field devices 507 in the automation system 500. Based on this, the operation of the automation system 500 may be optimized.

According to an embodiment, the field bus protocol used is a HART protocol. The respective communication information 411 defines corresponding HART commands, with the aid of which data communication based on the HART protocol is allowed for between the communication gateway 400 and the field devices 507 of the automation system 500.

According to an embodiment, the internal database 407 of the communication gateway 400 is in the form of at least one JSON file.

The data communication between the control station 505 and the field devices 507 of the automation system 500 may be carried out according to a further embodiment according to the NAMUR Open Architecture NOA.

For this purpose, the communication network 501, including the OPC-UA client 502 or the control station 505, the field devices 507 and the communication gateway 400, defines an existing second communication channel for data communication between the field devices 507 and a controller of the automation system 500. The data communication via the communication network 501 may thus take place in parallel with the data communication between the controller and the field devices 507.

The operating information 405 transmitted to the communication gateway 400 via the communication messages 419 of the field devices 507 may thus be provided in addition to the user data provided to the controller of the automation system 500 by the field devices 507 during the control cycles. The communication network 501 may thus be used to achieve data communication between the field devices 507 and the controller of the automation system 500 that is largely independent of the cyclical data communication.

According to an embodiment, the communication gateway 400 and/or the OPC-UA server 403 and/or the internal database 407 are integrated into a controller, for example a programmable logic controller PLC.

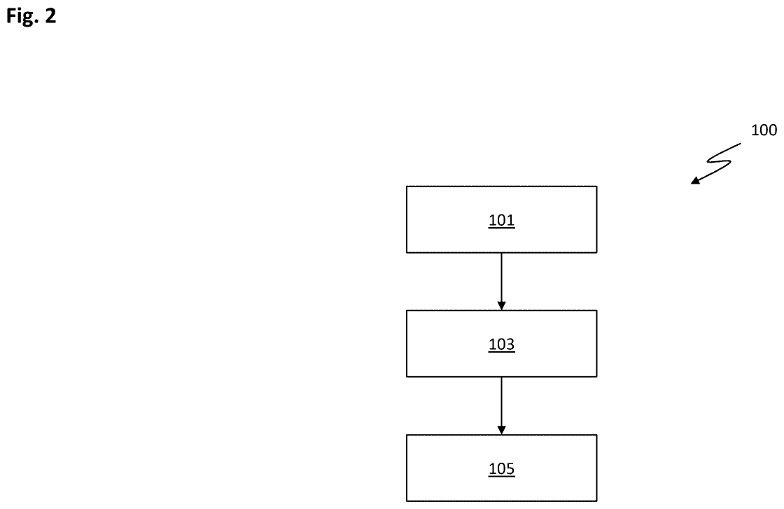

FIG. 2 shows a flowchart of a computer-implemented method 100 for generating a communication network 501 between at least one OPC-UA client 502 and at least one field device 507 of an automation system 500 according to an embodiment.

In order to generate a communication network 501 between at least one OPC-UA client 502 and at least one field device 507 of an automation system 500, at least one field device 507 of the automation system 500 is first identified by a communication gateway 400 of the automation system 500 in an identifying step 101.

The identification may be used to determine at least one device type of the respective identified field device 507.

The identification of the field devices 507 may be carried out for selected field devices 507. As an alternative or in addition, a plurality of field devices 507, possibly all field devices 507 of the automation system 500, may be identified.

The identification may be carried out, for example, during a drive-up of the automation system 500.

As an alternative or in addition, the identification may be carried out repeatedly at predetermined intervals during operation of the automation system 500.

As an alternative or in addition, the identification, in particular of selected field devices 507, may be carried out when predefined events occur.

These predefined events may include, for example, a new integration of a field device 507 into the existing automation system 500. The newly integrated field device 507 would thus be automatically identified by the communication gateway 400.

As an alternative or in addition, such an event may comprise an update of the external database 509 of the external server 511. The external database 509 is accessible to the manufacturers of the field devices 507. In the event of changes to existing field devices 507 or new developments of new field devices 507, the external database 509 may be provided with corresponding information by the respective manufacturers of the field devices 507.

Via the wireless data connection 515 between the communication gateway 400 and the external server 511, the information of the external database 509 may be integrated into the internal database 407 of the communication gateway 400 in order to keep the internal database 407 of the communication gateway 400 up to date.

When changes are made to the internal database 407 of the communication gateway 400, the existing communication networks 501 may be regenerated according to the steps described above to take into account any new information in the updated internal database 407.

In a generating step 103, at least OPC-UA node set 401 is then generated for the identified field device 507 by the communication gateway 400. The OPC-UA node set 401 is adapted to the device type of the identified field device 507 in accordance with the OPC-UA communication standard.

In a node set storing step 105, the at least one OPC-UA node set 401 of the identified field device 507 is stored on an OPC-UA server 403 of the communication gateway 400. The OPC-UA node set 401 stored on the OPC-UA server 403 may be called up by at least one OPC-UA client 502. Furthermore, operating information 405 of the respective identified field device 507 may be stored in the OPC-UA node set 401 and may therefore be read by the OPC-UA client 502.

According to the application, the correspondingly generated communication network 501 comprises at least one OPC-UA client 502, at least one identified field device 507 and the communication gateway 400 connected in terms of data technology both to the OPC-UA client 502 and to the field device 507.

Data communication between the OPC-UA client 502 and the respective field device 507 of the generated communication network 501 may thus be moderated via the communication gateway 400.

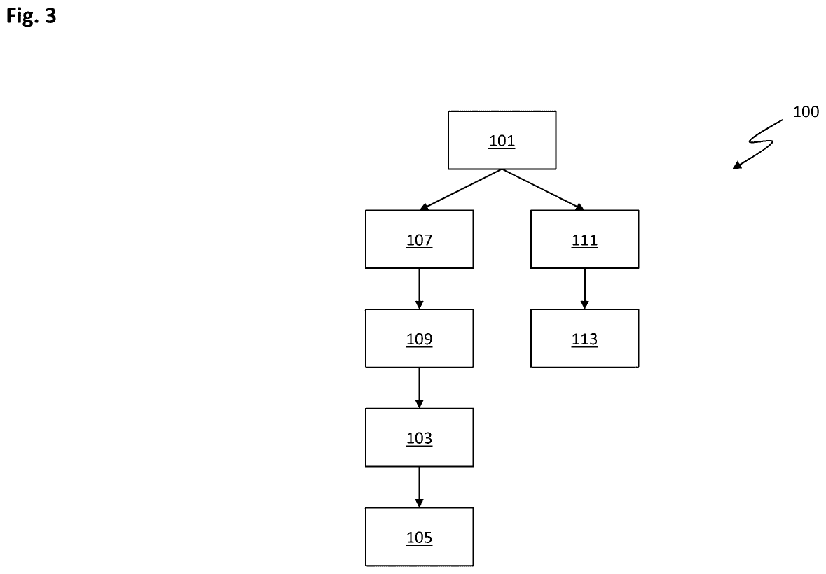

FIG. 3 shows a further flowchart of the computer-implemented method 100 for generating a communication network 501 between at least one OPC-UA client 502 and at least one field device 507 of an automation system 500 according to a further embodiment.

The embodiment shown is based on the embodiment in FIG. 2 and comprises all the process steps described there.

In contrast to the embodiment in FIG. 2, in the embodiment shown, after identifying the field device 507 or the plurality of field devices 507, in a first read-out step 107, the communication gateway 400 reads out at least one piece of configuration information 409 relating to the respective identified field device 507 from an internal database 407.

The configuration information 409 comprises information relating to a configuration of the OPC UA node set 401 of the respective field device 507.

For example, the configuration information 409 may include mapping associations that define associations between the operational information 405 or operational parameters that may be provided by the field device 507 and the corresponding OPC UA variables of the respective OPC UA node sets 401 associated with the field devices 507.

The corresponding data structures of the non-instantiated OPC-UA node sets 401 may, for example, be stored in the converting module 425 for this purpose. Alternatively, the data structures of the non-instantiated OPC-UA node sets 401 are stored in another memory location in such a way that the converting module 425 may access them and instantiate the non-instantiated OPC-UA node sets 401 with the aid of the conversion information 409.

The operating information 405 or operating parameters that may be provided by the field devices 507 may include, for example, a measured variable, such as a temperature or a pressure with a corresponding unit or an operating time, an average, maximum or minimum utilization of the field device 507, a scheduled maintenance date, an expected service life, or similar parameters describing the operation or functionality of the respective field device 507.

In a subsequent converting step 109, the communication gateway 400 converts the configuration information 409 read from the internal database 407 into the corresponding OPC UA node set 401 of the respective identified field device 507.

For this purpose, the converting module 425 may adapt the data structures of the non-instantiated OPC-UA node sets 401 predefined for the individual field devices 507 individually to the respective field devices 507, for example to a field device 507 newly integrated into the automation system 500, in accordance with the mapping allocations and generate an instantiated OPC-UA node set 401 on this basis. In the instantiated OPC-UA node set 401, at least one variable of the OPC-UA node set 401 is clearly defined in accordance with the conversion information 409 of the internal database 407 for each operating parameter that may be provided by a respective field device 507, into which a respective value of the operating parameter is to be written.

The predefined data structures of the non-instantiated OPC UA node sets 401 are defined here in accordance with the regulations of the OPC UA protocol standard and, if applicable, in accordance with corresponding companion specifications for a field device 507 of the respective type.

As an alternative or in addition to the first read-out step 107, the communication gateway 400 also reads out communication information 411 from the internal database 407 for the respective identified field device 507 in a second read-out step 111.

The communication information 411 defines at least one communication command 413 of a field bus protocol for the respective field device 507. The communication command 413 is embodied to drive the field device 507 to transmit or to provide the at least one operating parameter or to provide the operating information 405 in a data communication of the communication gateway 400 with the respective field device 507.

Depending on the complexity of the respective field device 507 or depending on the number of different operating information 405 including different operating parameters that may be provided by the field device 507 in a data communication, the communication information 411 for the respective field device 507 may comprise a corresponding number of communication commands 413. A communication command 413 may be precisely tailored to the request for a specific operating parameter.

In a command storing step 113, the at least one communication command 413 of the communication information 411 of the respective field device 507 is then stored in the communication gateway 400. By storing the at least one communication command 413 in the communication gateway 400, the communication gateway 400 is set up to drive the respective field device 507 in a data communication to provide the corresponding operating information 405.

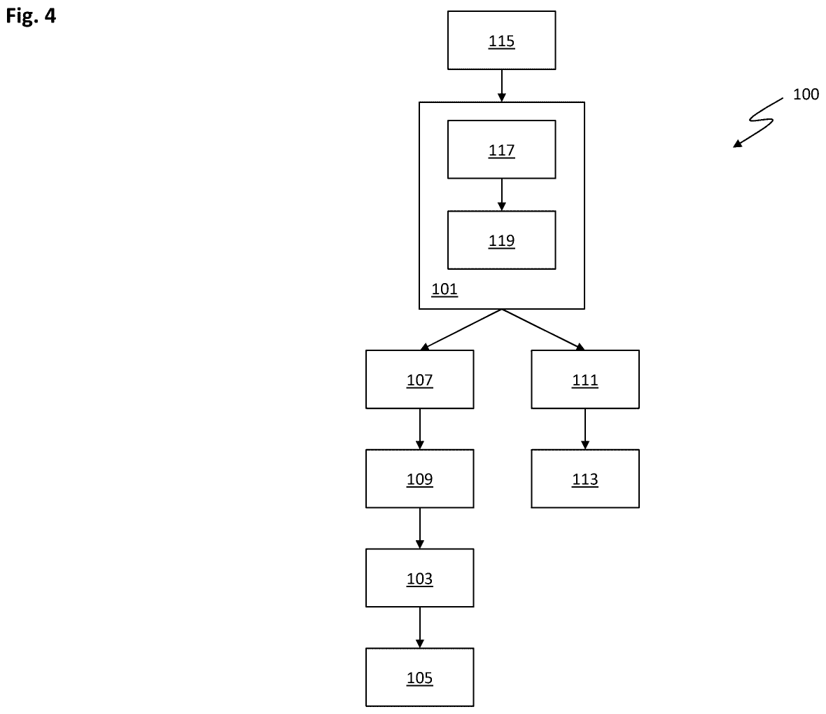

FIG. 4 shows a further flowchart of the computer-implemented method 100 for generating a communication network 501 between at least one OPC-UA client 502 and at least one field device 507 of an automation system 500 according to a further embodiment.

The embodiment shown is based on the embodiment in FIG. 3 and comprises all the method steps described there.

In the embodiment shown, the communication gateway 400 first copies configuration information 409 and/or communication information 411 from the external database 509 to the internal database 407 in a copying step 115.

Copying may take place automatically at predetermined time intervals. As an alternative or in addition, the copying may be event-driven when a predefined event occurs, such as when the automation system 500 is started, when a new field device 507 is added to the automation system 500, or when the information of the external database 509 is updated or changed.

In contrast to the embodiment in FIG. 3, in the embodiment shown, the identification of the at least one field device 507 by the communication gateway 400 in the identifying step 101 comprises the execution of a transmitting step 117.

In transmitting step 117, the communication gateway 400 transmits an identification command 415 to the field devices 507 of the automation system 500. The identification command 415 is in this context set up to drive the respective field devices 507 to transmit an identification response 417 after receiving the respective identification command 415.

The identification command 415 may be sent to individual selected field devices 507, to a plurality of field devices 507 or preferably to all field devices 507 of the automation system 500.

In a receiving step 119, an identification response 417 of the respective field devices 507 is received by the communication gateway 400 to identify the field devices 507. The identification response 417 comprises at least one device identifier of the respective field device 507, via which the field device 507 may be identified. The identification of the respective field device 507 may comprise at least the determination of a device type of the respective field device 507.

After setting up the OPC-UA node sets 401 in the OPC-UA server 403 according to the configuration information 409 stored for the respective field devices 507 in the internal database 407 and after storing the respective communication information 411 stored in the internal database 407 for the respective field devices 507, including the communication commands 413 contained therein, the communication gateway 400 is set up for data communication with the respective field devices 507.

The respective communication network 501 is thus installed.

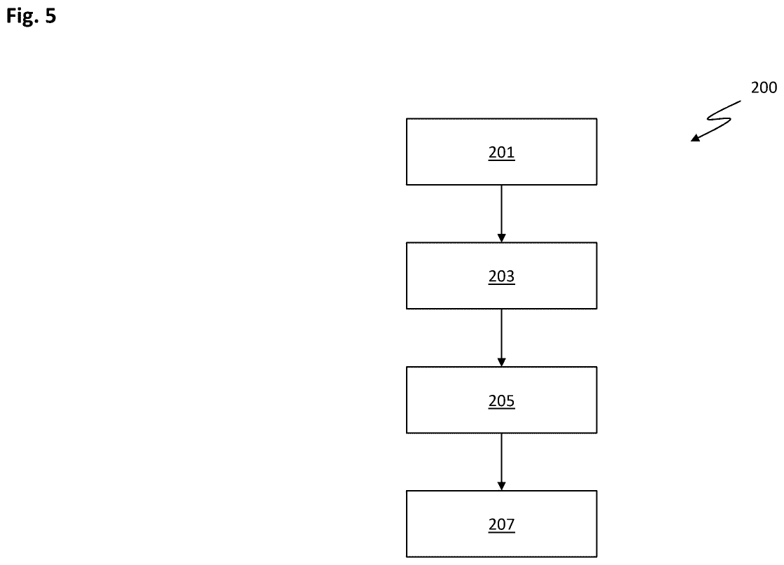

FIG. 5 shows a flowchart of a computer-implemented method 200 for data communication between an OPC-UA client 502 and at least one field device 507 of an automation system 500 according to an embodiment.

For data communication between an OPC-UA client 502 and at least one field device 507 of the automation system 500, a communication network 501 is first generated between the OPC-UA client 502 and the at least one field device 507 of the automation system 500 in a network generating step 201 by carrying out the method 100 according to the application described above for generating a communication network 501.

In a message receiving step 203, after successful generation of the communication network 501 via the communication gateway 400, a communication message 419 of a field device 507 is received. The communication message 419 comprises at least one operating information 405 of the respective field device 507. The operating information 405 comprises at least one operating parameter of the field device 507.

In an information storing step 205, the operating parameter of the operating information 405 of the field device 507 is then stored in the OPC-UA node set 401 stored on the OPC-UA server 403 for the respective field device 507.

By storing the operating parameter of the field device 507 in the OPC-UA node set 401, the OPC-UA client 502, which is connected to the communication gateway 400 via data communication and may access the OPC-UA server 403 and the OPC-UA node sets 401 stored on it, is provided with the information relating to the respective operating parameter, i.e. the operating information 405 of the respective field device 507, in a providing step 207.

The OPC-UA client 502 may then read in the information contained in the operating information 405 relating to the operating parameter by calling up the respective OPC-UA node set 401 of the respective field device 507. As an alternative or in addition, the respective information may be uploaded by the OPC-UA client 502 to a PC or external server or the like.

This is used for data communication between the OPC UA client 502 and the respective field device 507.

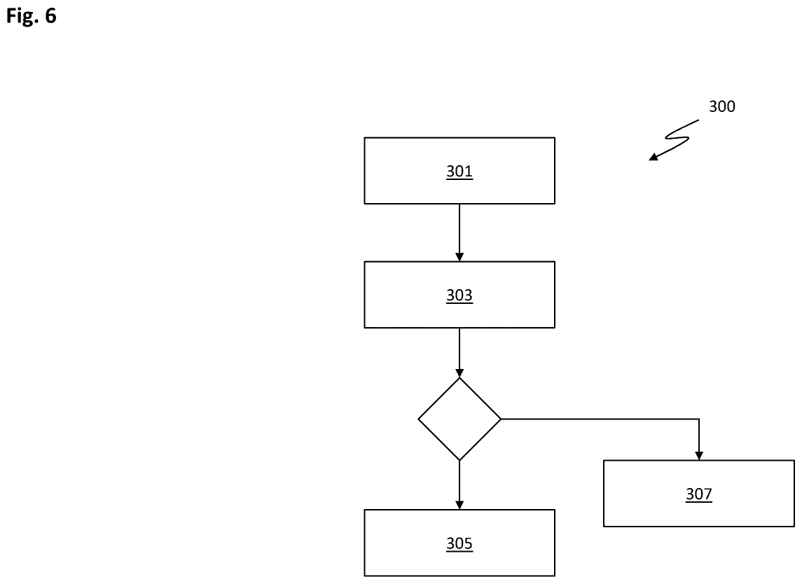

FIG. 6 shows a flowchart of a computer-implemented method 300 for analyzing data of operational information 405 of a field device 507 by an OPC-UA client 502 of an automation system 500 according to an embodiment.

In order to carry out a data analysis of operational information 405 of a field device 507 via an OPC-UA client 502, in an information receiving step 301, operational information 405 of a corresponding field device 507 provided according to the method 200 for data communication between an OPC-UA client 502 and at least one field device 507 described above is first received by the respective OPC-UA client 502.

As described above, the receiving may comprise the reading of the operational information 405 stored in the respective OPC-UA node set 401 by the OPC-UA client 502 and/or the uploading of the respective operational information 405 of the OPC-UA node set 401 to the OPC-UA client 502, i.e., the control station 505.

In an analyzing step 303, the operational information 405 is analyzed by the OPC UA client 502.

The analysis of the operating information 405 or, in particular, the operating parameters of the respective field device 507 contained therein may comprise various analyzing steps 303.

For example, a utilization of a field device 507 may be determined by analyzing the operating hours carried out by the field device 507 up to the time of the data analysis. As an alternative or in addition, malfunctions of the field device 507 may be identified or analyzed.

As an alternative or in addition, it is possible to check whether the respective field device 507 is being operated in the load range provided for this purpose.

As an alternative or in addition, a predefined maintenance date of the respective field device 507 may be identified or evaluated in the analysis.

The possible analyzing steps 303 mentioned here are merely exemplary and are not intended to limit the present application.

In addition to the steps mentioned here, further analyzing steps 303 are also conceivable, which may vary depending on the design of the respective field device 507 or depending on the use of the respective field device 507 in the automation system 500.

If a malfunction of the field device 507 and/or an exceeding of a limit value defined for the operating time of the field device 507 and/or an expired service life of the field device 507 and/or a due date for maintenance of the field device 507 is determined in the analysis of the operating information 405, an action instruction to stop the operation of the respective field device 507 and/or to replace the respective field device 507 is output in an output step 305.

In addition to the above-mentioned conditions, other conditions may also result in a corresponding action instruction being issued when the respective condition is identified during the analysis.

The action instruction may, for example, be issued by the control station 505 to a controller of the automation system 500 in order to stop the execution of the respective field device 507.

If, on the other hand, the analysis of the analyzing step 303 does not detect any of the aforementioned conditions that lead to an action instruction being issued in accordance with the output step 305, operation of the respective field device 507 in the automation system 500 is continued in an operating step 307.

This invention has been described with respect to exemplary embodiments. It is understood that changes can be made and equivalents can be substituted to adapt these disclosures to different materials and situations, while remaining with the scope of the invention. The invention is thus not limited to the particular examples that are disclosed, but encompasses all the embodiments that fall within the scope of the claims.

TABLE 1
List of reference numerals

100 Method
101 Identifying step
103 Generating step
105 Node set storing step
107 First selecting step
109 Converting step
111 Second selecting step
113 Command storing step
115 Copying step
117 Transmitting step
119 Receiving step
200 Method
201 Network generating step
203 Message receiving step
205 Information storing step
207 Providing step
300 Method
301 Information receiving step
303 Analyzing step
305 Output step
307 Operating step
400 Communication gateway
401 OPC-UA Node set
403 OPC-UA Server
405 Operating information
407 Internal database
409 Configuration information
411 Communication information
413 Communication command
415 Identification command
417 Identification response
419 Communication message
421 Field-bus module
423 Parsing module
425 Converting module
427 Communication interface
500 Automation system
501 Communication network
502 OPC-UA Client
503 Terminal
505 Control station
507 Field device
509 External database
511 External server
513 Cloud server
515 Wireless data connection
516 Further wireless data connection
517 Field bus

1. A computer-implemented method for generating a communication network between at least one OPC-UA client and at least one field device of an automation system, comprising:
identifying at least one of the field devices of the automation system by a communication gateway of the automation system configured for data communication with said at least one field device, in an identifying step;
generating an OPC UA node set for the identified field device via the communication gateway, in a generating step; and
storing the OPC-UA node set on an OPC-UA server, in a node set storing step,
wherein the communication gateway comprises the OPC UA server,
wherein the OPC-UA node set stored on the OPC-UA server is callable by at least one OPC-UA client of the automation system, and
wherein operating information provided in a data communication by the identified field device is storable in the OPC-UA node set and readable by the OPC-UA client.

2. The method according to claim 1, wherein generating the OPC-UA node set comprises:
reading out, from an internal database of the communication gateway, at least one piece of configuration information relating to the identified field device via the communication gateway, in a first read-out step,
wherein the configuration information comprises information relating to a configuration of the OPC UA node set; and
converting the configuration information read out from the internal database into the OPC UA node set, in a converting step.

3. The method according to claim 2, further comprising:
reading out, from the internal database, at least one piece of communication information relating to the identified field device via the communication gateway, in a second read-out step,
wherein the communication information defines at least one communication command of a field bus protocol, and
wherein the identified field device is configured to be driven via the communication command to transmit the at least one operating parameter to the communication gateway; and
storing the at least one communication command in the communication gateway, in a command storing step.

4. The method according to claim 2, wherein the internal database comprises configuration information and/or communication information relating to a plurality of different instances of the at least one field device.

5. The method according to claim 2, wherein the configuration information and/or communication information of the internal database are provided by one or more manufacturers of the at least one field device.

6. The method according to claim 2, further comprising:
copying configuration information and/or communication information relating to a plurality of said at least one field device from an external database into the internal database configured on the communication gateway via the communication gateway, in a copying step,
wherein the internal database is configured on an external server.

7. The method according to claim 1, wherein the identified field device is a field device integrated into the automation system.

8. The method according to claim 1, wherein the identifying step comprises:
transmitting an identification command via the communication gateway to one or more of the field devices of the automation system, in a transmitting step; and
receiving an identification response of the one or more field devices via the communication gateway, in a receiving step,
wherein at least one device identifier of the one or more field devices is defined in the identification response.

9. A computer-implemented method for data communication between an OPC-UA client and at least one field device of an automation system operating according to claim 1, comprising:
generating the communication network between the OPC-UA client and the at least one field device of the automation system via the communication gateway, in a network generating step;
receiving a communication message from a field device of said at least one field device via the communication gateway, in a message receiving step,
wherein the communication message contains at least one item of operating information relating to at least one operating parameter of the field device;
storing the operational information related to the operational parameter of the field device in the OPC-UA node set on the OPC-UA server, in an information storing step; and
providing the operating information relating to the operating parameter of the field device for the OPC-UA client via the OPC-UA node set of the OPC-UA server by the communication gateway, in a providing step.

10. The method according to claim 9, wherein:
communication messages of the field device are cyclically received by the communication gateway, and
operation information of the communication messages is correspondingly cyclically stored in the OPC-UA node set of the OPC-UA server.

11. The method according to claim 9, wherein the operating parameter of the field device comprises an operating time and/or an operating performance and/or a maintenance condition and/or a lifetime and/or a next maintenance date of the field device.

12. The method according to claim 9, wherein the operational information of the field device stored in the OPC-UA node set is provided to the OPC-UA client via a point-to-point channel and/or a message channel and/or a publisher-subscriber channel and/or a message bus and/or a data type channel.

13. A computer-implemented method for data analysis of operational information of at least field device by an OPC-UA client of an automation system operating according to claim 1, and further comprising:
receiving, via the OPC-UA client, the operational information provided for data communication between an OPC-UA client and a field device of said at least one field device of the automation system, in an information receiving step;
analyzing the operational information by the OPC UA client, in an analyzing step; and
outputting an action instruction for stopping an operation of the field device and/or for replacing the field device, in an output step, if the analysis has determined a malfunction and/or an operating time that has exceeded a limit value and/or an operating performance that has exceeded a limit value and/or a specific maintenance state and/or an expired service life and/or a maintenance date of the field device.

14. A communication gateway for data communication of an OPC-UA client and at least one field device of an automation system, wherein the communication gateway is configured to carry out the method for generating a communication network according to claim 1.

15. The communication gateway according to claim 14, wherein the communication gateway comprises:
an internal database containing configuration information and/or communication information relating to a plurality of different field devices; and/or
a field bus module, the field bus module being configured to send communication commands to field devices in a field bus protocol and/or to receive communication messages from field devices and/or to identify field devices; and/or
a parsing module, wherein the parsing module is configured to read out configuration information and/or communication information relating to the field devices of the automation system from the internal database,
wherein the configuration information comprises information relating to a configuration of the OPC-UA node set,
wherein the communication information defines at least one communication command of a field bus protocol, and
wherein a field device is configured to be driven via the communication command to transmit at least one operating information of the field device to the communication gateway; and/or
a converting module, wherein the converting module is configured to generate a corresponding OPC UA node set for each identified field device of the automation system based on the configuration information of the field devices; and/or
an OPC-UA server for storing the OPC-UA node sets of the identified field devices; and/or
an OPC-UA communication interface,
wherein the communication gateway is configured to be connected to an OPC-UA client via the OPC-UA communication interface, and
wherein the OPC-UA node is available to the OPC-UA client via the OPC-UA communication interface.

16. A communication gateway for data communication of an OPC-UA client and at least one field device of an automation system, wherein the communication gateway is configured for data communication between an OPC-UA client and at least one field device of an automation system operating according to claim 9.

17. The communication gateway according to claim 16, wherein the communication gateway comprises:
an internal database containing configuration information and/or communication information relating to a plurality of different field devices; and/or
a field bus module, the field bus module being configured to send communication commands to field devices in a field bus protocol and/or to receive communication messages from field devices and/or to identify field devices; and/or
a parsing module, wherein the parsing module is configured to read out configuration information and/or communication information relating to the field devices of the automation system from the internal database,
wherein the configuration information comprises information relating to a configuration of the OPC-UA node set,
wherein the communication information defines at least one communication command of a field bus protocol, and
wherein a field device is configured to be driven via the communication command to transmit at least one operating information of the field device to the communication gateway; and/or
a converting module, wherein the converting module is configured to generate a corresponding OPC UA node set for each identified field device of the automation system based on the configuration information of the field devices; and/or
an OPC-UA server for storing the OPC-UA node sets of the identified field devices; and/or
an OPC-UA communication interface,
wherein the communication gateway is configured to be connected to an OPC-UA client via the OPC-UA communication interface, and
wherein the OPC-UA node is available to the OPC-UA client via the OPC-UA communication interface.
